(19) United States
(12) Patent Application Publication
(10) Pub. No.: US 2025/0100505 A1
(43) Pub. Date: Mar. 27, 2025

(54) VEHICLE THEFT PROTECTION SYSTEM

(71) Applicants: Dmitrii Nikolaevich FEDOROV, Kirovsky (RU); Andrei Alekseevich TUTIN, Sankt-Peterburg (RU)

(72) Inventors: Dmitrii Nikolaevich FEDOROV, Kirovsky (RU); Andrei Alekseevich TUTIN, Sankt-Peterburg (RU)

(21) Appl. No.: 18/642,867

(22) Filed: Apr. 23, 2024

(30) Foreign Application Priority Data
Sep. 24, 2023 (RU) 2023124510

(51) Int. Cl. B60R 25/00

(52) U.S. Cl. CPC B60R 25/003

(57) ABSTRACT

The invention relates to technology for protecting vehicles from unauthorized influence and can be used for installation on vehicle models equipped with a standard multiplex data exchange bus between electronic units and functional parts of the vehicle. The technical results consist in increasing the efficiency of vehicle protection against theft and increasing the reliability of the protection system. The main unit and actuators are connected without breaking the conductors to the standard digital line of the vehicle and to the analog line of the vehicle. The operating algorithm makes it difficult to determine the cause of vehicle immobilization.

### FIELD OF TECHNOLOGY TO WHICH THE INVENTION RELATES

The invention relates to technology for protecting vehicles from unauthorized influence and can be used for installation on vehicle models equipped with a standard multiplex data exchange bus between electronic units and functional parts of the vehicle.

### PRIOR ART

Traditional methods of protecting vehicles from theft include analog protection, carried out by opening the electrical circuits of the vehicle, for example, through controlled relays.

Thus, from the patent prior art (RU 2309861 C1, Nov. 10, 2007-[1]) an electromechanical relay is known, designed with the ability to connect its contacts to the functional parts and mechanisms of the vehicle and to alarm units. Examples of functional parts and mechanisms to which the contacts of the relay known from [1] can be connected (to block vehicle movement) are a fuel pump, a crankshaft position sensor and other similar functional parts and mechanisms.

The disadvantage of the solution known from [1] is that using only an electromechanical relay allows an attacker, for example, by characteristic errors on the instrument panel, or by connecting a diagnostic device and reading a set of errors/faults or by the sound of switching contacts to determine with sufficient accuracy break point (i.e. the location of the open relay) and directly short circuit the conductors of the electrical circuit. In addition, the use of a relay of this type reduces the reliability of the system due to the limited service life of the contact group.

There is also known solution from patent RU 2714557 C2, Feb. 18, 2020 ([2]), which is a method of preventing vehicle theft. According to the known method, the system is equipped with transceivers that ensure communication of its nodes via a radio channel. The method involves physical intervention in the topology of the standard CAN-bus of the vehicle, for which bus blocking devices are installed in the CAN-bus gap and irrevocably break it at the command of the processor unit.

The disadvantage of the solution known from [2] is the ease of detection by an attacker of the very presence, as well as the location of system nodes, for example, using an electromagnetic field scanner and connecting the analyzer to the vehicle diagnostic connector. In addition, an irreversible break in the standard vehicle CAN-bus makes it impossible to implement multi-stage vehicle protection, complicates the operation of the protection system and generally reduces the reliability of not only the protection system, but also the functioning of the vehicle.

A more complex version of vehicle protection includes the solution known from patent RU 2179122 C1, Feb. 10, 2002 ([3]). The complexity of the known solution is due to the division of the system into security and anti-theft parts, each of which is controlled via separate radio channels—from the user's key ring fob and via a paging communication channel from a remote control center. The disadvantages of the solution known from [3], in addition to the noted complexity of implementation, also include low reliability due to the possibility of an attacker blocking the paging radio channel, as a result of which the operation of the anti-theft part of the system will not be feasible. Obviously, the operation of the system will also not be possible outside the coverage area of the paging operator, which does not allow such a system to be considered autonomous.

The proposed invention is aimed at overcoming the above-mentioned disadvantages of the prior art and, when implemented, makes it possible to achieve the main technical results, namely, increasing the effectiveness of vehicle protection against theft and increasing the reliability of the protection system.

### DISCLOSURE OF THE INVENTION

To achieve the above, as well as other technical results that follow for a specialist from this description, a vehicle anti-theft protection system is proposed, containing a main unit connected by signal reception/transmission lines to actuator units connected to the functional elements of the vehicle. The system contains actuators selected from the group: an actuator connected to the main unit via an analog signal reception/transmission line and/or an actuator connected to the main unit via a standard digital signal reception/transmission line and/or an actuator connected to the main unit via a wireless signal reception/transmission line, wherein the main unit is configured to determine compliance with at least one security condition and, if this condition is met, provide a mode for disarming the vehicle, and if this condition not observed, transmission of commands to actuators to perform the functions prescribed to them, the implementation of which leads to immobilization of the vehicle, whereas the actuator is connected directly to the main unit via an analog signal transmission/reception line, and the actuator is connected to the main unit via a standard digital receiving/transmission line signal transmission, and is made with the ability to analyze signals coming through this line both from the main unit and from the functional bodies of the vehicle, while the signals coming from the main unit characterize commands, and the signals coming from the functional bodies of the vehicle characterize events, according to the results of the analysis of which the actuator performs the function prescribed to it, the specified actuator is connected to the standard digital line for receiving/transmitting signals without breaking its conductors, in addition, the main unit is additionally connected to the standard digital line for receiving/transmitting signals and is configured to transmit a signal through it, leading to immobilization of the vehicle, in case of non-compliance with at least one safety condition and/or the main unit is configured to transmit a signal via a standard digital signal reception/transmission line to the functional body of the vehicle for immobilizing the vehicle, determining an unsuccessful attempt to immobilize the vehicle and, in the event of an unsuccessful attempt to immobilize the vehicle, transmission of a command through an analog signal reception/transmission line to the actuator after a predetermined time interval.

The following section of the description provides detailed information regarding the implementation of the invention, as well as embodiments intended to describe the invention in relation to its development or refinement.

### CARRYING OUT (IMPLEMENTATION OF) THE INVENTION

This section of the description shows a preferred embodiment of the invention, presented for the purpose of disclosing the essence, but not for the purpose of limiting the legal protection defined by the claims. A specialist will understand that the invention may be subject to minor technical changes, for example, in the case of the emergence of new communication protocols, which do not affect the achievement of new technical results, but have an impact on the obvious quantifiable improvement in the technical and operational characteristics of the product.

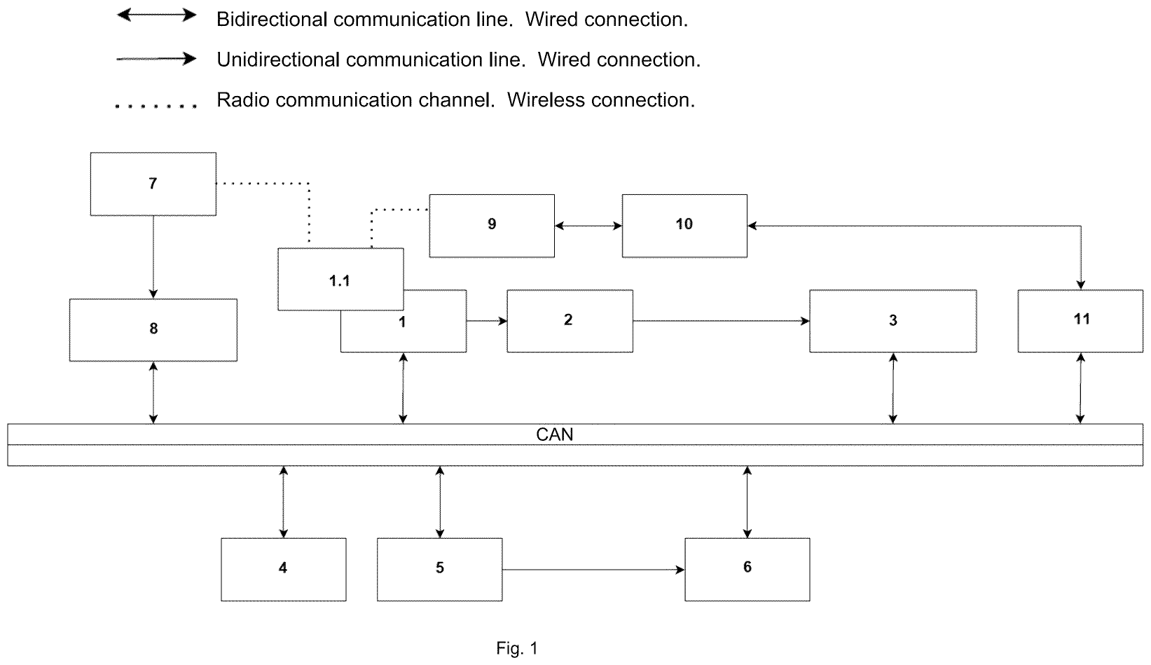

For a clearer understanding of the essence of the invention, reference is made in the description to the explanatory drawing (FIG. 1). It should be understood that the explanatory drawing relates to an illustrative embodiment of the invention. The presence of some blocks and connections between them reflected in the drawing is optional, and therefore, during implementation, the invention can be modified by excluding or supplementing the system with certain blocks in combinations that are provided for in this description.

In the proposed solution, the term “main unit”, or “main block” refers to the central system control unit, which has two-way connections with vehicle buses, with functional bodies of the vehicle, with actuators, with user devices (if the appropriate option is available). The main unit can be made, for example, based on a microcontroller, and also have a memory module, power supply and information reception/transmission interfaces, bus drivers, and wireless communication modules.

In the proposed solution, the term “signal reception/transmission line” is understood as a digital or analog line, which provides the ability to propagate electrical or optical signals along it, while the “signal” is understood as both an element of information and an electrical signal (for example, intended to implement power supply of any element).

The term “digital line” for the purposes of this description preferably refers to the standard vehicle digital line, which in a non-limiting embodiment may be one or a combination of known vehicle buses, for example: CAN, UART, LIN, IMO-IMI or W-BUS.

The term “executive device” in the proposed solution, unless otherwise noted, means any technical tool designed to implement the function prescribed to it when realising external influence (wired or wireless). In various embodiments, the actuator may include a relay and/or a semiconductor switch and/or a pulse noise generator. The functions of the actuator may include, for example, the function of opening the electric current circuit or sending a control signal to a functional element of the vehicle.

In the proposed solution, the term “functional element” in relation to a vehicle means any standard or non-standard unit included in the vehicle, the control of which can lead to the impossibility of starting the vehicle engine or lead to a stop in the movement of the vehicle. In general, both are covered by the term “immobilization” in this specification. In non-limiting versions, the functional parts of the vehicle may include a fuel pump, crankshaft position sensor, gearbox, hood lock, door locks, ignition unit, etc.

In the proposed solution, a wireless line is understood as any receiving/transmitting line that has the ability to propagate a signal through electromagnetic radiation, in particular cases selected from Wi-Fi, Bluetooth, NB-IoT, LoRaWAN, NFC, RFID, and the like.

In general, the proposed invention is illustrated in FIG. 1, according to the positions of which are presented:

1—main block; 1.1—radio unit; 2—analog actuator; 3—functional unit of the vehicle; 4—vehicle display elements; 5—digital-analog actuator; 6—functional unit of the vehicle; 7—actuator with radio path; 8—functional unit of the vehicle, 9—radio programmer; 10—user's personal computer; 11—programmer.

According to the proposed invention, the vehicle anti-theft protection system contains a main unit connected by signal reception/transmission lines to actuator units that are connected to the functional parts of the vehicle. In an embodiment, the main unit (1) includes a radio unit (1.1) that provides communication with the actuator (7), which is connected to the functional unit (8) of the vehicle.

Moreover, according to the invention, the system assumes the presence of several types of actuators—an actuator (2) connected to the main unit via an analog signal reception/transmission line, an actuator (5) connected to the main unit via a standard digital receive/transmit line signal transmission, actuator (7) connected to the main unit via a wireless signal reception/transmission line.

According to the control program embedded in the controller included in the main unit, the main unit provides the ability to determine compliance with at least one safety condition. The security condition includes at least one of the following: the presence/absence of a radio frequency tag in the vehicle interior or in a predetermined area around the vehicle; presence/absence of authorized communication between the main unit and the user's mobile device; presence/absence of code entry by the user through manipulation of standard vehicle controls.

In an illustrative embodiment, when the vehicle is in arming mode, the main unit (via a built-in one or an additional radio unit) detects the presence of a radio frequency tag in the vehicle interior, authorizes the user and switches to the vehicle disarming mode. In an alternative or additional embodiment, user authorization is carried out by the main unit by exchanging information with a mobile device (for example, a smartphone) of the user with the appropriate software installed on it. In an alternative or additional embodiment, the main unit determines the fact that the user has entered a preset code, and entering such a code involves the user's manipulation by physically influencing the standard vehicle controls (for example, to disarm the vehicle, the user must press the rear window heating button three times, once the air conditioning button and again three times the heated rear window button). It is also possible for the user to manipulate, for example, the gas and brake pedals.

It should be noted, that the ability to disarm a vehicle by manipulating controls that are not in the field of view of a potential attacker, increases the effectiveness of the vehicle protection from theft. In the above considered options, arming the vehicle can be carried out automatically upon expiration of a specified period of time, when the ignition is turned off and when there is a lack of communication between the main unit and the user's radio frequency tag or mobile device, or through the user's influence on the standard vehicle controls. The need for the user to enter a code in a similar manner as shown above could also be due to the operation of the main unit in emergency mode.

When changing the mode, the main unit is configured to control the standard vehicle indicators located inside the vehicle interior to generate feedback signals for the user. It is significant that the standard vehicle indication devices, which are controlled by the main unit, are outside the field of observation of vehicle passengers. For example, indicators located on the vehicle instrument panel can be used as such means. Executing the system in the noted manner will allow you to hide the fact that an additional security system is installed in the vehicle.

Otherwise, if the safety condition is not met, the main unit transmits commands to the actuators to perform the functions prescribed to them, the implementation of which leads to immobilization of the vehicle. Immobilization implies either the inability to set the vehicle in motion (including the inability to start the engine) or stopping the vehicle.

In the proposed solution, one actuator is connected directly to the main unit via an analog line, and the other actuator is connected to the main unit via a standard digital line, and the main unit is configured to transmit commands to the actuators via both analog and standard digital lines. This implementation makes it possible to use an algorithm according to which the main unit, by analyzing traffic on the standard digital line, is able to determine that the previous attempt to immobilize the vehicle by sending a command to the actuator via the standard digital line was not successful (for example, the digital line traffic is still contains information transmitted by the functional element whose work was to be terminated). When determining the specified event, the main unit, after a predetermined time interval, transmits a command via an analog line to the corresponding actuator, which opens the circuit, leading to immobilization of the vehicle, for example, through a semiconductor switch. The implementation described above makes it possible to increase the reliability of the system, as well as significantly increase the time required for an attacker to determine the reasons for immobilizing the vehicle. The use of a semiconductor switch improves the performance and reliability of the system.

It should also be noted that in the proposed solution, the system units can be connected to a standard digital line without breaking its conductors, which simplifies the installation of the units and increases the complexity of diagnosing their presence.

Due to the fact that in the proposed solution the main unit is connected to a standard digital line, it is possible to influence the functional elements of the vehicle not only through actuators, but also directly from the main unit. For example, when a violation of a safety condition is detected, the main unit can block a functional element by suppressing its ID (for example, CAN ID) in the digital bus. This ensures that the car cannot receive, for example, data from the standard key or about switching the automatic transmission from the automatic transmission joystick and, as a result, the impossibility of opening the car lock or the impossibility of starting the engine, or the impossibility of switching the automatic transmission to the vehicle driving mode.

In addition, in the embodiment, the main unit and at least one actuator are configured to update the software built into them via a wireless communication channel and/or via a standard digital line. This function can be used when installing the system on a specific vehicle model, as well as to configure its operation by the user during operation.

Thus, the essential features of the proposed invention make it possible to achieve all the above technical results and the implementation of the invention can be implemented by a specialist using known methods in the field of electrical and radio engineering.

1. A vehicle (vehicle) anti-theft protection system containing a main unit connected by signal reception/transmission lines to actuator units connected to the functional bodies of the vehicle, wherein it contains actuators selected from the group: an actuator connected to the main unit via an analog signal reception/transmission line and/or an actuator connected to the main unit via a standard digital signal reception/transmission line and/or an actuator connected to the main unit via a wireless signal reception/transmission line, wherein the main unit is made with the ability to determine compliance with at least one safety condition and, if this condition is met, to ensure the mode of disarming the vehicle, and if this condition is not met, to transmit commands to actuators to perform the functions prescribed to them, execution which leads to immobilization of the vehicle, and the actuator is connected directly to the main unit via an analog signal reception/transmission line, and the actuator connected to the main unit via a standard digital signal reception/transmission line is configured to analyze the signals arriving via this line as from the main unit and from the functional bodies of the vehicle, while the signals coming from the main unit characterize commands, and the signals coming from the functional bodies of the vehicle characterize events, based on the analysis of which the actuator performs the function prescribed to it, the specified actuator is connected to the standard digital line for receiving/transmitting signals without breaking its conductors, in addition, the main unit is additionally connected to the standard digital line for receiving/transmitting signals and is configured to transmit a signal through it leading to immobilization of the vehicle in case of non-compliance with at least one safety condition and/or the main unit is configured to transmit a signal via a standard digital line for receiving/transmitting signals to the functional body of the vehicle to immobilize the vehicle, determine an unsuccessful attempt to immobilize the vehicle and, in the event of an unsuccessful attempt to immobilize the vehicle, transmit a command through a predetermined time interval analog line for receiving/transmitting signals to the actuator.

2. The system according to claim 1, wherein the actuator contains a relay and/or a semiconductor switch and/or a pulse noise generator.

3. The system according to claim 1, wherein the events represent telemetry data and/or the presence/absence of traffic in a standard digital signal transmission/reception line.

4. The system according to claim 1, wherein the result of the function is a break in the electrical circuit of the vehicle and/or blocking of a functional element of the vehicle.

5. The system according to claim 4, wherein the standard digital signal transmission/reception line is a standard CAN bus or another standard vehicle bus, for example, UART, LIN, IMO-IMI or W-BUS.

6. The system according to claim 5, wherein the blocking of a functional body of the vehicle is carried out by suppressing traffic in the standard vehicle bus, for example, suppressing CAN ID of the corresponding functional body of the vehicle.

7. The system according to claim 1, wherein the main unit is configured to control standard vehicle indicators located inside the vehicle cabin to generate feedback signals for the user, while the standard vehicle indicators are outside the field of view of vehicle passengers.

8. The system according to claim 1, wherein the main unit and at least one actuator are configured to update the software built into them via a wireless communication channel and/or via the standard CAN bus of the vehicle.

9. The system according to claim 1, wherein the main unit is additionally configured to operate in emergency mode, requiring the user to enter a code, while the code is entered by manipulating the standard vehicle controls, for example, the gas and brake pedals.

10. The system according to claim 1, wherein the security condition includes at least one of: the presence/absence of a radio frequency tag in the vehicle interior or in a predetermined area around the vehicle; presence/absence of authorized communication between the main unit and the user's mobile device; presence/absence of code entry by the user through manipulation of standard vehicle controls.
